(19) United States
(12) Patent Application Publication
(10) Pub. No.: US 2010/0233365 A1
(43) Pub. Date: Sep. 16, 2010

(54) TUBING WITH AN INNER COATING PROTECTING IT AGAINST DEPOSITS AND A METHOD FOR APPLYING SAID COATING

(76) Inventors: Malik Favzavierich Gajsin, Ekaterinburg (RU); Aleksandr Nikolaevich Piljugin, Ekaterinburg (RU); Firdaus Usmanovich Zamaleev, Ekaterinburg (RU)

Correspondence Address: Firdaus Usmanovich Zamaleev, ul. Cherkasskaja 10, Ekaterinburg, 620043, RU

(21) Appl. No.: 12/733,964

(22) PCT Filed: Feb. 4, 2009
(86) PCT No.: PCT/RU2009/000047

§ 371 Date: Mar. 31, 2010

(30) Foreign Application Priority Data
Dec. 27, 2007 (RU) 2007-149567

(51) Int. Cl. B05D 7/22

(52) U.S. Cl. 427/230

(57) ABSTRACT

A method for applying a coating to a tubing is provided, wherein the tubing includes inner walls and end faces. A plug, having outer walls, is inserted into the tubing, so that the longitudinal axes of the plug and tubing coincide and internal space is provided between the inner and the outer walls. The inner walls are preferably heated up. Polyurethane is pumped into the internal space until it's filled up. Polyurethane is held to the full cure thereof. The plug is then extracted from the tubing, thereby producing the coating. The outer walls are preferably lubricated. Optionally, a reinforcement tube is inserted into the tubing. The tube is configured as a web made of perforated metal, and has a diameter equal to the inner diameter of tubing. Two mandrels are provided, so configured that can centering the plug during the insertion, and are fitted onto the end faces.

### CROSS-REFERENCE TO RELATED APPLICATIONS

This application is a U.S. national stage application of a PCT application PCT/RU2009/000047 filed on 4 Feb. 2009, published as WO/2009/084987, whose disclosure is incorporated herein in its entirety by reference, which PCT application claims priority of a Russian Federation application RU2007149567 filed on 27 Dec. 2007.

### FIELD OF THE INVENTION

The present invention relates to the oil and gas industry, more particularly to prevention of deposits (asphaltene-resin-paraffin, salt, hydrated deposits, etc.) on the inner surface of compression pump pipes (CPPs), and can be used to coat the inner surface of CPPs in any hydrocarbon raw materials production method (oil or gas) independent on wellbores exploitation conditions and the quality of extracted raw materials.

### BACKGROUND OF THE INVENTION AND RELATED ART

There is known a method for coating the inner surface of CPPs, providing a one- or multilayer coating thereof, formed, for example, by using a film ribbon being depressed against the CPP surface due to creating a pressure difference (see Patent of Russian Federation RU2144803, published on 27 Apr. 2000).

The drawback of the aforementioned method is a difficulty in creation of a uniformed coating of the inner surface of CPP by, low adhesion of coating to the CPP surface, and low resistance to extra aggressive surroundings.

There is known a method for coating the inner surface of tubing with polymer material, comprising the application of such material in a viscous flowing state on the inner surface of CPP, and its subsequent solidification. (see Patent of Russian Federation RU2118742, published on 10 Sep. 1998).

The drawback of the aforesaid method is that the quick cooling of melted polymer in the thermo-mechanical module makes it impossible to provide a homogenized coating layer or a strong bond between the polymer and the CPP surface due to intensive thermo shrinkage processes in the polymer mass. The movement of the thermo-mechanical module along the pipe changes the length of the connection element between the extruder and the module, as well as the conditions in which polymer passes along this element, which reduces the coating quality and polymer's adhesion to the metal walls of CPP.

There is known a method for coating the CPP surfaces with thermoplastic by means of a pressure casting process, which comprises: placing a metal tube into a mould, introducing thermoplastic material brought to a thick-flowing state, heating the mould, and subsequent solidification and removal of the material from the mould (see Patent of Russian Federation RU2184903, published on 10 Jul. 2002).

The drawbacks of the foregoing method are process complexity and significant costs associated with mould manufacture, particularly for large-size tubes, as well as inapplicability of the aforesaid method to tubes having a diameter of less than 200 mm.

The closest related art device in terms of technical substance is a steel compression pump pipe (CPP, or a tubing string, herein also called ‘tubing’) having a smooth inner wall coating made of dielectric polymer material, e.g. polyethylene (see a USSR inventor's certificate 124896 filed 14 Mar. 1959 called “Method of Overcoming Paraffin Deposits in Lift Pipes of Oil Wellbores and Oil Pipelines”).

The aforementioned device however has a shortcoming of insufficient quality of the coating (the cover layer is not homogenized) and insufficient cohesion of the polymer material with the metal walls due to an intense thermo-shrinkage process during the cooling of polymer mass, and also due to insufficient heat insulation properties that cannot prevent a sharp temperature difference on the CPP walls.

One of the unsolved problems in the oil and gas industry in the world is deposits on the walls of tubing used in oil and gas wellbores for production of hydrocarbon raw materials (oil and gas). This process starts from the moment when the production begins in any climatic conditions and continues until the tubing is totally clogged. The deposits cause accelerated wear of the pump equipment, an increase of costs and time spent on cleaning the tubing, a pressure fall in the tubing due to a decrease of the cross-section flow area, which increases a percentage of underproduction of the hydrocarbon raw materials.

Depending on the quality of hydrocarbon raw materials, the time period between the tubing cleaning operations at different fields varies from one day to one year. For example, at Buzulukskoe field, a removal of paraffin deposits is done every 1÷15 days depending on the wellbore; this period for Tumen fields is 5÷20 days, for Surgut fields this period is 7÷30 days.

Therefore, the problem still persists. The present invention has solved the problem by proposing a tubing and a method for coating the inner surface of the tubing, based on detailed analysis of the causes of deposit formation on the inner surface thereof.

There are three major factors contributing to the formation of deposits on the inner surface of tubing:
1F) Roughness of the inner surface of tubing.
2F) Static stress on the inner surface of tubing during the flowing of oil.
3F) Temperature difference on the wall of tubing.

The aforesaid factors provide a basis for outlining the requirements to the tubing and the method of coating thereof preventing the formation of deposits:
1 R) The coating width should range from 2 to 8 mm in order to reduce the heat conduction and to avoid a sharp temperature difference on the wall of tubing.
2R) A high degree of cleanliness of the coating surface, i.e. a glossy surface should be provided.
3R) Preventing the static stress from building up.

Apart from the above specified requirements, including those designed to prevent deposit formation, the coating should have the following properties:
1P) Resistance to aggressive surroundings (e.g. corrosive media, such as acids, alkali, etc.).
2P) Structure uniformity, good adhesion to metal, and water tightness in order to prevent corrosion of the inner surface of tubing.
3P) Elasticity, resistance to cracking associated with impact loads and bending of the tubing at a temperature of up to −60° C.
4P) Resistance to abrasion associated with a flow of suspended particles with a hardness of up to 7 points on the Moss scale.
5P) Maintaining the coating properties within the temperature range of −60÷+110° C.

### OBJECTIVES OF THE INVENTION

The primary objective of the proposed technical solution is to create a tubing and a method for coating the inner surface of the tubing; preventing the formation of deposits; and providing a long service life of the coating used in any hydrocarbon raw materials production method, independent on the wellbore service conditions, the quality of extracted raw materials, and in accordance with the requirements specified above. Other objectives may become apparent to a person skilled in the art upon learning the present disclosure.

### DESCRIPTION OF DRAWING

FIG. 1 illustrates a sectional view of a tubing with a coating, according to a preferred embodiment of the present invention.

FIG. 2 illustrates a sectional view of a tubing with a coating and an internal reinforcement tube, according to another preferred embodiment of the present invention.

### DESCRIPTION OF PREFERRED EMBODIMENTS OF THE INVENTION

While the invention may be susceptible to embodiment in different forms, there are shown in the drawing, and will be described in detail herein, specific embodiments of the present invention, with the understanding that the present disclosure is to be considered an exemplification of the principles of the invention, and is not intended to limit the invention to that as illustrated and described herein.

Investigative research and multiple tests provided a basis for selection of a material meeting the above specified requirements. According to the research, a polyurethane compound has been selected, whose characteristics are shown in the Table 1 below. This compound should be preferably used for carrying out the invention, though other suitable compounds can be considered as well.

TABLE 1
Main Characteristics of Polyurethane Compound

| Technical parameters | Value | |
|---|---|---|
| Shore hardness DIN 53516 | 80-95 | A |
| Tensile strength DIN 53504 | 13-45 | N/mm² |
| Elongation at break DIN 53504 | 500-600% | |
| Tear strength DIN 53515 | 10-50 | N/mm |
| Abrasion DIN 53516 | 8-25 | mg |

| | |
|---|---|
| Compression set 23° C./72 h DIN 53517 | 11-19% |
| Compression set 70° C./24 h [symbol] H 53517 | 30-45% |
| Rebound resilience DIN 53512 | 70-75% |
| Service temperature range | −60 . . . +110° C. |
| Mechanical memory on impact load | 100% |

The aforementioned polyurethane compound allows achieving a technical result that provides for a high degree of adhesion of polyurethane to the inner surface of tubing, a glossy surface of coating of a predetermined width, and ensures meeting the aforesaid requirements.

The technical result is achieved by an inventive method involving:—pumping polyurethane into an annular cavity which is formed by the internal surface of the tubing and a plug (movable die), which is inserted into the tubing, preferably by means of suitable mandrels, and has a predeterminedly high quality finished surface;—holding the polyurethane to the full cure thereof; and—subsequently extracting the plug from the tubing, thereby enabling the polyurethane to be fully adhered to the inner metal wall of the tubing, and to obtain the internal coating, having a brightly finished (glossy) surface and a uniform thickness.

According to the polyurethane shrinkage ratio, the tubing can optionally be provided with an internal reinforcement tube preferably made of a perforated metal web (mesh), wherein the outer diameter of the tube is equal to the inner diameter of the tubing.

Also, when required by the processing of some polyurethanes, prior to the pumping of polyurethane, the tubing can be heated to a required temperature by means of any known method.

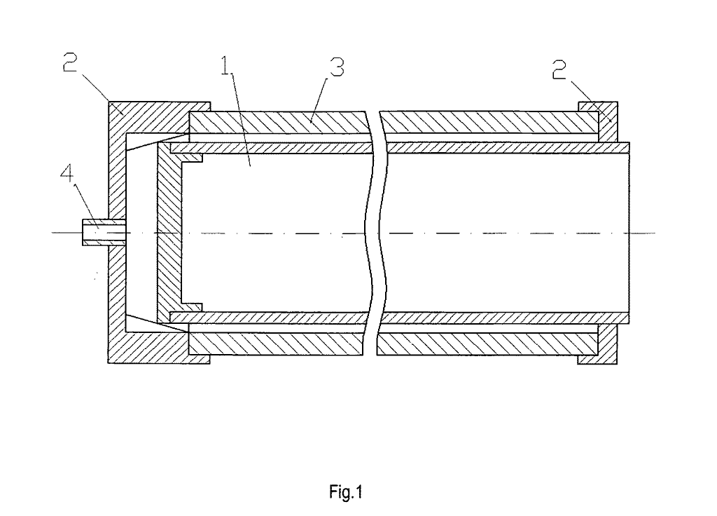

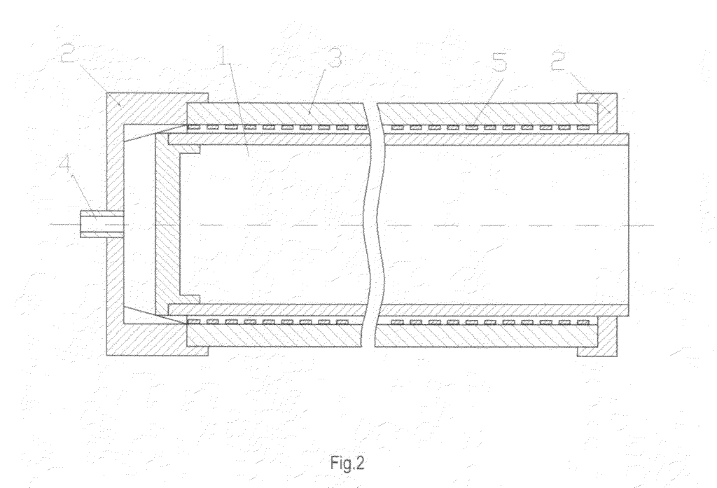

In a preferred embodiment, the assembling of the inventive tubing and the coating method include the following operations:
1O) Scale, dust, and moisture are removed from the inner surface of a tubing (3), the inner surface is then degreased.
2O) A plug (1) of a cylindrical shape with a predeterminedly finished outer surface (preferably, a minimum external surface finish should be of class 9), is inserted into the cleaned and degreased tubing (3), depicted on FIG. 1. The plug's external diameter provides for a gap between the plug (1) and the inner wall of tubing (3), equal to a predetermined coating width (preferably 2-8 mm).
3O) Prior to the aforesaid insertion of the plug (1) into the tubing (3), the plug's external surface is preferably lubricated with a suitable separating lubricant in order to facilitate a subsequent removal of the plug (1).
4O ) When the polyurethane's shrinkage factor exceeds 2%, then prior to the insertion of the plug (1) into the tubing (3) a reinforcement (preferably webbed) tube (5) (e.g., as shown on FIG. 2), for example made of perforated metal, with an external diameter equal to the internal diameter of the tubing and a thickness preferably not exceeding 1.5 mm, is preferably inserted into the interior space between the tubing (3) and the plug (1). The reinforcement tube (5) resists to the shrinkage of polyurethane, which provides a coating with better uniformity and high adhesion to the inner wall of tubing.
5O ). The plug (1) is preferably centered by means of mandrels (2) which are fitted onto the end faces of the tubing (3), with one of the mandrels having a connection pipe (4) for pumping polyurethane in (FIG. 1). The centering of the plug is provided so that the longitudinal axes of the tubing and the plug coincide.
6O). To meet process requirements for processing some types of polyurethane, the tubing is preferably heated to a predetermined temperature usually not exceeding 80° C., for instance using a tubular heating element, a furnace or any other known device of this type.
7O). To prevent the formation of voids in the coating, the tubing should be preferably installed in the vertical position with the connection pipe (4) at the bottom, then the polyurethane mass is pumped in via the connection pipe (4) until the space between the tubing (3) and the tube (5) is filled up.
8O). After the complete solidification of polyurethane, the plug (1) is taken out of the tubing (3) preferably in the horizontal position.
9O). The tubing faces are machined to remove any burrs.

The use of this tubing and the above described method for coating the tubing, combined with the specified material, provides a homogenized coating of equal width, a glossy surface, high resistance to aggressive surroundings (e.g. corrosive media), high adhesion to the inner surface of tubing, high resistance to abrasion, high temperature resistance, which prevents the formation of deposits and the related consequences, increases the time between routine and overhaul repairs of production wellbores and ultimately extends the service life of the tubing.

1-2. (canceled)

3. A method for applying a coating to a tubing, said tubing having a longitudinal axe, inner walls with a surface, end faces, and a predetermined inner diameter; said method comprising the steps of:
a) providing a plug having a longitudinal axe, outer walls, and a predetermined outer diameter, said plug is insertable into said tubing, said outer walls have a predetermined quality finished surface;
b) inserting said plug into said tubing so that the longitudinal axe of said plug substantially coincide with the longitudinal axe of said tubing so that an internal space is provided between the inner walls of said tubing and the outer walls of said plug;
c) pumping a polyurethane compound into said internal space until it is filled up;
d) holding said polyurethane compound to the full cure thereof; and
e) extracting said plug from said tubing, thereby producing said coating.

4. The method according to claim 1, further comprising the step of:
a1) degreasing the surface of said inner walls prior to the step (a).

5. The method according to claim 1, wherein said internal space has a width ranging from 2 to 8 mm.

6. The method according to claim 1, further comprising the step of:
b1) lubricating the surface of said outer walls prior to the step (b).

7. The method according to claim 1, further comprising the step of:
a2) providing a reinforcement tube with an external diameter substantially equal to the inner diameter of said tubing, and inserting said reinforcement tube into said tubing prior to the step (b).

8. The method according to claim 7, wherein said reinforcement tube is configured as a web made of perforated metal, and has a thickness not exceeding 1.5 mm.

9. The method according to claim 1, wherein two mandrels are provided, said mandrels are predeterminedly configured so that the mandrels are capable of centering said plug during the step (b); and said mandrels are fitted onto the end faces of said tubing.

10. The method according to claim 9, wherein one of said mandrels is furnished with a connection pipe so configured that the polyurethane compound is pumped through said connection pipe into said internal space during the step (c).

11. The method according to claim 1, wherein said tubing is heated up to a predetermined temperature prior to the step (c).

12. The method according to claim 11, wherein said predetermined temperature does not exceed 80° C.

13. The method according to claim 1, wherein said tubing is installed in a substantially vertical position prior to the step (c).

14. The method according to claim 10, wherein said tubing is installed in a substantially vertical position prior to the step (c), so that said connection pipe is located at the bottom of said tubing.

15. The method according to claim 1, wherein said tubing is installed in a substantially horizontal position immediately prior to the step (e).

17. The method according to claim 1, wherein said end faces are machined to remove any burrs after the step (e).

18. A method for applying a coating to a tubing, said tubing has: a longitudinal axe, inner walls with a surface, two end faces, and a predetermined inner diameter; said method comprising the steps of:
A) degreasing the surface of said inner walls of said tubing;
B) providing a plug having a longitudinal axe, outer walls, and a predetermined outer diameter, said plug is insertable into said tubing, said outer walls have a predetermined quality finished surface;
C) lubricating the surface of said outer walls of said plug;
D) providing a reinforcement tube with an external diameter substantially equal to the inner diameter of said tubing;
E) inserting said reinforcement tube into said tubing;
F) providing two mandrels, predeterminedly configured so that to enable centering said plug inside said tubing; said two mandrels are fitted onto the end faces of said tubing; one of said two mandrels has a connection pipe;
G) inserting said plug into said tubing so that said plug is supported by said mandrels, and the longitudinal axe of said plug substantially coincides with the longitudinal axe of said tubing thereby providing an internal space between the inner walls of said tubing and the outer walls of said plug, whereas said reinforcement tube is situated within said internal space;
H) positioning said tubing with said plug substantially vertically, so that the connection pipe is located at the bottom of said tubing;
I) heating up said tubing to a predetermined temperature;
J) pumping a polyurethane compound through said connection pipe into said internal space until it is filled up;
K) holding said polyurethane compound to the full cure thereof;
L) installing said tubing with said plug in a substantially horizontal position; and
M) extracting said plug from said tubing, thereby producing said coating.

19. The method according to claim 18, wherein: said internal space has a width ranging from 2 to 8 mm; said reinforcement tube is configured as a web made of perforated metal, and has a thickness not exceeding 1.5 mm; said predetermined temperature does not exceed 80° C.; and said end faces are machined to remove any burrs after the step (M).
